(19) United States
(12) Patent Application Publication
(10) Pub. No.: US 2023/0348310 A1
(43) Pub. Date: Nov. 2, 2023

(54) METHOD FOR PRODUCING GLASS ARTICLE

(71) Applicant: Nippon Electric Glass Co., Ltd., Shiga (JP)

(72) Inventors: Yuusuke TOMITA, Shiga (JP); Tatsuya KISE, Shiga (JP); Toshiro FUJIWARA, Shiga (JP); Nobuhiro YAMAMOTO, Shiga (JP); Ryosuke YOMORI, Shiga (JP)

(21) Appl. No.: 18/019,150

(22) PCT Filed: Aug. 10, 2021
(86) PCT No.: PCT/JP2021/029564

§ 371 Date: Feb. 1, 2023

(30) Foreign Application Priority Data
Aug. 31, 2020 (JP) 2020-145610

(51) Int. Cl. C03B 17/06; C03B 35/16

(52) U.S. Cl. CPC C03B 17/068; C03B 17/067; C03B 35/164

(57) ABSTRACT

A method for producing a glass article includes a forming step (P1) of forming a glass ribbon (2) from a molten glass (6) and a transport step (P2) of transporting the glass ribbon (2) along a transport path. In the transport step (P2), a first roller (9a) and a second roller (9b) configured to transport the glass ribbon (2) while in contact with a first end portion (2s) and a second end portion (2t) of the glass ribbon (2) in the width direction, respectively, are disposed, and a speed difference is provided between the first roller (9a) and the second roller (9b).

### TECHNICAL FIELD

The present invention relates to a method for producing a glass article.

### BACKGROUND ART

Glass substrates used in displays such as liquid crystal displays, plasma displays, and organic EL displays are getting thinner, as demand for light weight displays increases. As a result, a thin glass film with a reduced thickness of, for example, 300 μm or less, or 200 μm or less, has been developed and produced.

As an example of a method for producing a glass film, Patent Document 1 discloses a producing method using a down-draw method, representative examples of which include the overflow down-draw method, the redraw method, and the slot down-draw method.

In the method disclosed in Patent Document 1, first, a glass ribbon (band-like glass film) from which a glass film is produced, is formed using the down-draw method (forming step). Next, the formed glass ribbon is transported in the vertical direction (vertical transport step), and then transported along a curved transport track so that the transport direction of the glass ribbon is changed from the vertical direction to the horizontal direction (transport direction changing step). To change the transport direction, a roller conveyor including a plurality of rollers disposed along the curved transport track is used. Then, while the glass ribbon after being subjected to the changing of the transport direction is transported in the horizontal direction (horizontal transport step), unnecessary portions at both the end portions of the glass ribbon in the width direction are cut off and separated (separation step). Furthermore, the glass ribbon from which the unnecessary portions have been separated is then wound around a winding core into a roll shape to form a glass roll (winding step). Thereafter, the glass ribbon wounded to form the glass roll is unwound from the winding core and cut along the width direction. In this way, a glass film is cut out from the glass ribbon and produced.

In the above-described method, the glass ribbon may be in an inappropriate state of being inclined with respect to the transport path, when the glass ribbon enters the roller conveyor that performs the transport direction changing step, after being subjected to the vertical transport step. In this case, twisting may occur between a part of the glass ribbon located upstream of the roller conveyor and a part of the glass ribbon located downstream of the roller conveyor, and such twisting may lead to breakage of the glass ribbon.

To solve the problem described above, in the method disclosed in Patent Document 1, a plurality of conveyors are disposed in parallel along the transport track described above for performing the transport direction changing step. The glass ribbon is transported by the plurality of conveyors, and the transport speed of each of the conveyors can be adjusted independently. This can provide different transport speeds of the glass ribbon, to the plurality of conveyors. That is, each part of the glass ribbon in the width direction can be transported by a corresponding conveyor at a different transport speed. This is used to avoid twisting of the glass ribbon and prevent breakage of the glass ribbon.

### CITATION LIST

### Patent Literature

Patent Document 1: JP 2016-113342 A

### SUMMARY OF INVENTION

### Technical Problem

Although the method described above can avoid twisting of the glass ribbon and prevent breakage of the glass ribbon, there still remain problems to be solved. Here, twisting of the glass ribbon is due to a dimension difference (a difference in length along the longitudinal direction of the glass ribbon) between a first end portion and a second end portion of the glass ribbon in the width direction. The dimension difference between both the end portions is due to a difference in elongation amount between the first end portion and the second end portion when the glass ribbon is formed.

Thus, twisting of the glass ribbon may occur again in steps subsequent to the transport direction changing step, and breakage of the glass ribbon may occur. Specifically, in the winding step in which the glass ribbon is wound around a winding core, it may be difficult to wind the glass ribbon due to wrinkles formed on one side of the glass ribbon in the width direction or twisting. This is the problem that remains. Thus, to fundamentally solve the problem caused by the dimension difference between both the end portions, it is necessary to equalize the elongation amounts of the first end portion and the second end portion of the glass ribbon in the width direction when the glass ribbon is formed.

Note that the problem caused by the dimension difference of both the end portions is not limited to the case where the glass film is produced by using the method described above. The problem may also arise in other cases where the glass ribbon is formed to produce a glass article that includes glass plates having a larger thickness than that of a glass film. For example, in a case of producing a glass plate cut from a glass ribbon, in which the glass ribbon after being subjected to the vertical transport step is cut along the width direction, while being continuously transported in the vertical direction, defects such as wrinkling and warping along one side of the cut glass plate arise.

A technical problem to be solved by the present invention that has been made in view of the above-described circumstances is, when a glass ribbon is formed in producing a glass article, to equalize elongation amounts of the first end portion and the second end portion of the glass ribbon in the width direction.

### Solution to Problem

A method for producing a glass article to solve the above-described problem includes a forming step of forming a glass ribbon from a molten glass and a transport step of transporting the glass ribbon along a transport path. In the transport step, a first roller and a second roller are disposed for the glass ribbon at a temperature within a temperature range of 300° C. or higher and configured to transport the glass ribbon while in contact with a first end portion and a second end portion of the glass ribbon in a width direction, respectively, and a speed difference is provided between the first roller and the second roller.

The method can provide, in the transport step, the speed difference between the first roller transporting the first end portion of the glass ribbon in the width direction and the second roller transporting the second end portion of the glass ribbon in the width direction. Providing the speed difference in this manner makes it possible to change the balance of elongation amount during forming between the first end portion and the second end portion of the glass ribbon. As a result, the change of the balance allows the elongation amount of the first end portion and the second end portion to be equalized.

The method described above preferably further includes a measurement step of measuring, along each of the first end portion and the second end portion of the glass ribbon, a length from a leading portion to a trailing portion of a measurement target section to obtain a first measured length and a second measured length, the measurement target section being a section along a longitudinal direction of the glass ribbon, and an adjustment step of adjusting the speed difference between the first roller and the second roller, based on a dimension difference between the first measured length and the second measured length.

In this case, performing the measurement step makes it possible to quantitatively grasp whether the elongation amounts of the first end portion and the second end portion of the glass ribbon are sufficiently equalized, based on the dimension difference between the first measured length and the second measured length. Performing the adjustment step of adjusting the speed difference between the first roller and the second roller based on the result obtained quantitatively as described above makes it possible to equalize the elongation amounts of the first end portion and the second end portion with high accuracy.

In the method described above, in a case where one of the first end portion and the second end portion of the glass ribbon having a relatively longer measured length based on the result of the measurement step is defined as a long end portion, and the other of the first end portion and the second end portion of the glass ribbon having a relatively shorter measured length is defined as a short end portion, in the adjustment step, the speed of one of the first roller and the second roller corresponding to the long end portion is preferably reduced, and the speed of the other of the first roller and the second roller corresponding to the short end portion is preferably increased.

In this case, as a result of performing the adjustment step, the elongation amount of the long end portion decreases and the elongation amount of the short end portion increases. Thus, the elongation amounts of the first end portion and the second end portion of the glass ribbon can be efficiently equalized.

In the method described above, the transport step preferably includes a cooling step of cooling the first end portion and the second end portion of the glass ribbon, while transporting the glass ribbon, and an annealing step of annealing the glass ribbon after being subjected to the cooling step, while transporting the glass ribbon, and the first roller and the second roller are used in at least one of the cooling step or the annealing step.

In the cooling step and the annealing step, the glass ribbon is in a state where the elongation amounts of the first end portion and the second end portion can be adjusted. In particular, in the annealing step, it is easy to adjust the elongation amounts of the first end portion and the second end portion. Thus, using the first roller and the second roller in at least one of the cooling step or the annealing step, makes it possible to effectively equalize the elongation amounts of the first end portion and the second end portion.

In the method described above, the first roller and the second roller preferably form a roller set, and a plurality of the roller sets are preferably disposed along the transport path.

In this case, the speed difference between the first roller and the second roller can be provided at a plurality of locations on the transport path of the glass ribbon, and thus the effect of equalizing the elongation amounts of the first end portion and the second end portion of the glass ribbon can be stably achieved.

In the method described above, a pair of rollers configured to sandwich the glass ribbon from both of front and back sides of the glass ribbon are preferably used for the first roller and the second roller.

In contrast to cases where the rollers are disposed only on the front side or the back side of the glass ribbon, using a pair of rollers sandwiching the glass ribbon from both the front and back sides of the glass ribbon makes it possible to easily adjust the elongation amounts of the first end portion and the second end portion by the first roller and the second roller, respectively. As a result, the effect of equalizing the elongation amounts can be achieved more stably.

In the method described above, the glass ribbon may be formed by using a down-draw method.

In the down-draw method, problems due to the dimension difference between the first end portion and the second end portion of the glass ribbon tend to occur frequently. Thus, if the present invention is applied to a case where the down-draw method is used to form a glass ribbon, the effect of the present invention will be suitably used.

The method described above may further include a winding step of winding the glass ribbon into a roll shape at a downstream end of the transport path to form a glass roll.

Since the elongation amounts of the first end portion and the second end portion of the glass ribbon can be equalized in the method described above, in the glass ribbon after being subjected to the transport step, the dimension difference between both the end portions can be minimized as much as possible. Thus, when the glass ribbon is wound in the winding step, it is possible to obtain a glass roll with no defects due to the dimension difference between both the end portions, such as wrinkles formed on one side in the width direction or twisting.

A method for producing a glass article to solve the above-described problem includes a forming step of forming a glass ribbon by using a down-draw method, a vertical transport step of vertically transporting the glass ribbon, a transport direction changing step of changing a transport direction of the glass ribbon from a vertical direction to a horizontal direction, by transporting, along a curved transport track, the glass ribbon after being subjected to the vertical transport step, and a horizontal transport step of horizontally transporting the glass ribbon after being subjected to the changing of the transport direction. In the vertical transport step, a first roller and a second roller configured to transport the glass ribbon while in contact with a first end portion and a second end portion of the glass ribbon in a width direction, respectively, are disposed, and a speed difference is provided between the first roller and the second roller.

### Advantageous Effects of Invention

In the present invention, when a glass ribbon is formed in producing a glass article, it is possible to equalize elongation amounts of a first end portion and a second end portion of the glass ribbon in the width direction.

### BRIEF DESCRIPTION OF DRAWINGS

FIG. 1 is a perspective view of a glass roll.

FIG. 2 is a plan view illustrating a state in which a glass ribbon forming the glass roll is virtually unwound from a winding core over the entire length of the glass ribbon.

FIG. 3 is a plan view illustrating a manner of measuring a first to third lengths of the glass ribbon.

FIG. 4a is a side view illustrating the manner of measuring the first to third lengths of the glass ribbon.

FIG. 4b is a side view illustrating the manner of measuring the first to third lengths of the glass ribbon.

FIG. 4c is a side view illustrating the manner of measuring the first to third lengths of the glass ribbon.

FIG. 5 is a side view illustrating a method for producing a glass article.

FIG. 6 is a plan view illustrating the method for producing the glass article.

FIG. 7 is a front view illustrating the method for producing the glass article.

### DESCRIPTION OF EMBODIMENTS

Hereafter, a method for producing a glass article according to an embodiment will be described with reference to the accompanying drawings.

### Glass Ribbon

First, description is given of a glass ribbon produced by using the method for producing a glass article according to the present embodiment. The entire length (length along a longitudinal direction) of the glass ribbon is extremely long, and thus the glass ribbon is typically wound to form a glass roll for storage or transport.

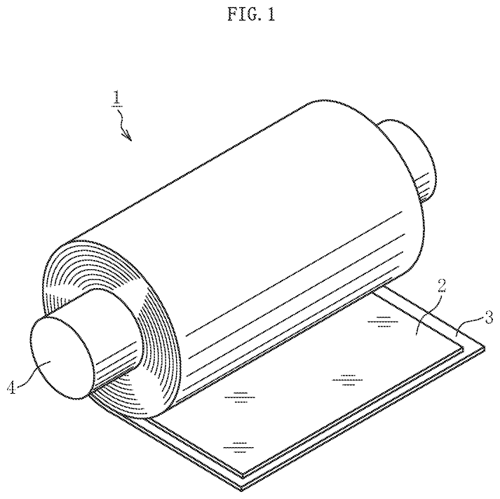

As illustrated in FIG. 1, a glass roll 1 is formed by a flexible glass ribbon 2 and a flexible band-like protective sheet 3 used for protecting the glass ribbon 2 from being damaged, which are layered and wound around a winding core 4 into a roll shape. The glass ribbon 2 has a substantially uniform thickness over the entire width of the glass ribbon 2, and the thickness is 300 μm or less, for example. Note that the thickness of the glass ribbon 2 is preferably 200 μm or less, more preferably 100 μm or less, and most preferably 50 μm or less. The lower limit of the thickness of the glass ribbon 2 is, for example, 10 μm. The entire length of the glass ribbon 2 is 100 m or greater, for example.

The band-like protective sheet 3 in the present embodiment has a greater width dimension than the glass ribbon 2, but the present invention is not limited thereto. In a variation of the present embodiment, the width dimensions of the glass ribbon 2 and the band-like protective sheet 3 may be the same, or the glass ribbon 2 may have a greater width dimension than the band-like protective sheet 3.

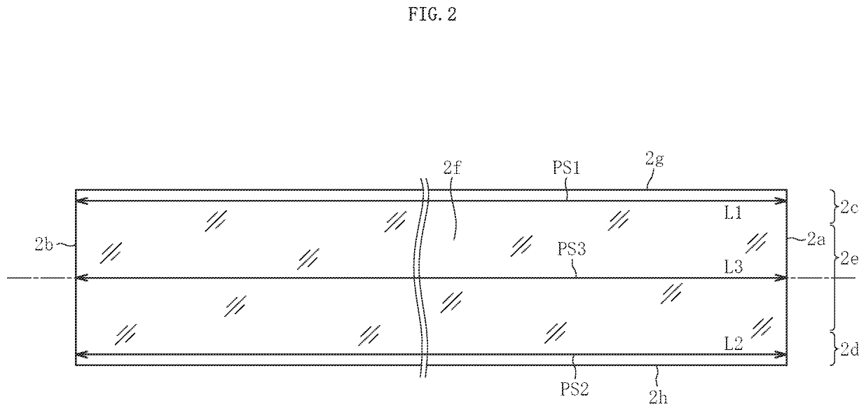

A state in which the glass ribbon 2 forming the glass roll 1 is virtually unwound from the winding core 4 over the entire length of the glass ribbon 2 is illustrated in FIG. 2. As illustrated in FIG. 2, the glass ribbon 2 has a leading portion 2a and a trailing portion 2b, which are one end portion and the other end portion of the glass ribbon 2 in the longitudinal direction, respectively. Both of the leading portion 2a and the trailing portion 2b are formed parallel to a width direction of the glass ribbon 2.

The glass ribbon 2 is a glass formed using the down-draw method (e.g., the overflow down-draw method). Here, thickened edge portions (portions having a greater thickness than other portions) formed at both the end portions in the width direction, as a result of the forming of the glass ribbon 2, have been separated and removed. The glass ribbon 2 includes a first end portion 2c in the width direction, a second end portion 2d in the width direction, and a central portion 2e. The first end portion 2c includes a first position PS1 described below, the second end portion 2d includes a second position PS2 described below, and the center portion 2e includes a center position PS3 in the width direction and is located between the first end portion 2c and the second end portion 2d.

A first length L1, a second length L2, and a third length L3 illustrated in FIG. 2 are the lengths along a surface 2f of the glass ribbon 2 from the leading portion 2a to the trailing portion 2b, and measured along the first position PS1, the second position PS2, and the center position PS3 in the width direction, respectively. As a result of the lengths L1 to L3 being measured along the surface 2f in this manner, an effect of recesses or projections in the surface 2f is reflected in the measurement result of each of the lengths L1 to L3, and the number of recesses or projections and the sizes of recesses and projections are reflected in the measured length.

The first position PS1 and the second position PS2 are positions spaced inward by 200 mm from an edge 2g on one side in the width direction of the glass ribbon 2 and an edge 2 h on the other side, respectively. In the present embodiment, a roller encoder 5 described below is used to measure each of the lengths L1 to L3 measured along the first position PS1, the second position PS2, and the center position PS3 in the width direction, respectively.

When the first length L1 to the third length L3 described above are measured, the dimension difference between the length measured along the first position PS1 and the length measured along the second position PS2, per 100 m of the length measured along the center position PS3 in the width direction, is 37 mm or less. In other words, when the glass ribbon 2 is divided into a plurality of sections each having a length of 100 m based on the length measured along the center position PS3 in the width direction, the difference between the length measured along the first position PS1 and the length measured along the second position PS2 is 37 mm or less, in each of the plurality of sections. The dimension difference is preferably 25 mm or less, and more preferably 15 mm or less. The dimension difference is, for example, 0 mm or greater, and is 10 mm or greater, in terms of suppressing an increase in producing costs.

### Manner of Measuring First to Third Lengths

Hereinafter, a manner of measuring the first length L1 to the third length L3 will be described.

A first manner of measuring the first length L1 to the third length L3 includes a manner described below. In the manner, the lengths L1 to L3 are measured on the transport path, in the course of forming the glass roll 1, the course including transporting the glass ribbon 2 formed using the down-draw method along the transport path, separating and removing unnecessary portions at both the end portions of the glass ribbon 2 in the width direction (portions including the thickened edge portion) from the glass ribbon 2 being transported, and then winding the glass ribbon 2 at the downstream end of the transport path to form the glass roll 1.

A second manner of measuring the first length L1 to the third length L3 includes a manner in which a so-called roll to roll is utilized. In the manner, the glass ribbon 2 forming the glass roll 1 is unwound from the winding core 4 which is the first winding core, and transported along a transport path, and the lengths L1 to L3 are measured on the transport path. Then, the glass ribbon 2 is wound around a second winding core which is different from the first winding core to form a glass roll again.

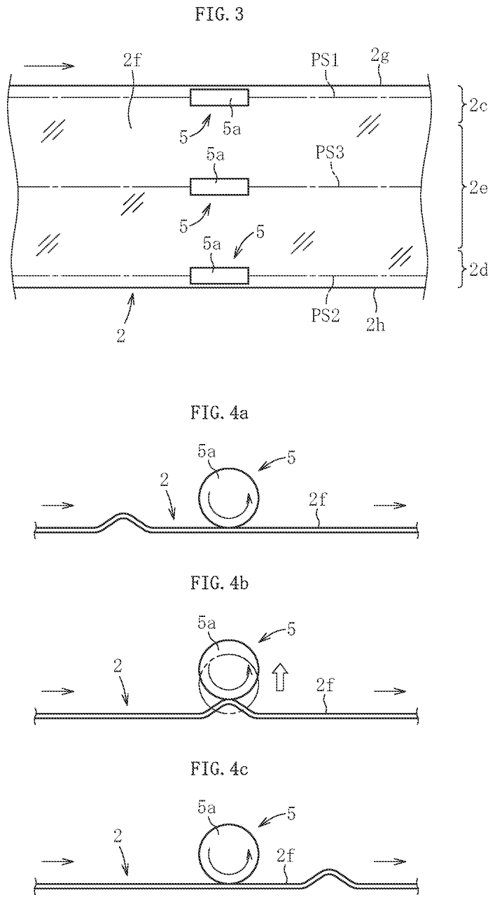

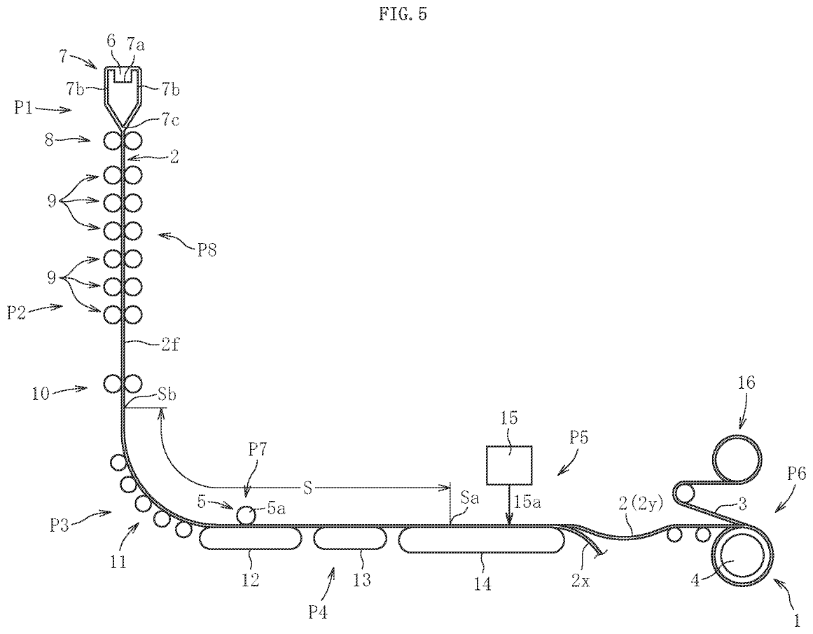

Here, a specific example of a case where measurement is performed in the first manner or the second manner will be described. In this specific example, as illustrated in FIGS. 3 and 4a to 4c, the glass ribbon 2 laid flat is transported on a transport means (not illustrated), such as a belt conveyor or a roller conveyor, and the first length L1 to the third length L3 are measured by using the roller encoder 5 in contact with the surface 2f of the glass ribbon 2.

A roller 5a provided in the roller encoder 5 can always be in contact with the surface 2f of the glass ribbon 2, and friction between the roller 5a and the surface 2f allows the roller 5a to rotate without slipping. Each of the lengths L1 to L3 is measured on the basis of a distance where the roller 5a rotated on the surface 2f.

As illustrated in FIG. 3, three roller encoders 5 are disposed for measuring the first length L1 to be measured along the first position PS1, the second length L2 to be measured along the second position PS2, and the third length L3 to be measured along the center position PS3 in the width direction, respectively. Three rollers 5a each provided in a corresponding one of the three roller encoders 5 are disposed along the width direction of the glass ribbon 2, and are located at the same position on the transport path of the glass ribbon 2.

As illustrated in FIGS. 4a to 4c, the roller 5a provided in each of the roller encoders 5 can move in the thickness direction of the glass ribbon 2, in accordance with a recess or projection of the surface 2f Note that in FIGS. 4a to 4c, a recess or projection of the surface 2f is represented in an exaggerated manner. When the roller 5a travels over a recess or projection during the transportation of the glass ribbon 2, the roller 5a moves upward from a position indicated by a two-dot chain line to a position indicated by a solid line in FIG. 4b. The roller 5a is configured to always apply a constant load (a load applied in the thickness direction of the glass ribbon 2) to the glass ribbon 2. The magnitude of the load is a magnitude such that the roller 5a can always be in contact with the surface 2f and a recess or projection is not crushed and flattened.

However, in a variation of the present embodiment, the magnitude of the load applied by the roller 5a to the glass ribbon 2 may be such a magnitude that the roller 5a crushes and flattens a recess or projection. In this case, the first length L1, the second length L2, and the third length L3 can also be measured without problems.

When the rollers 5a each provided in the corresponding roller encoder 5 at the first position PS1, the second position PS2, and the center position PS3 in the width direction, respectively, complete rotating, from the leading portion 2a to the trailing portion 2b, along the surface 2f of the glass ribbon 2, the measurement of the lengths L1 to L3 is completed.

### Method for Producing Glass Article

Hereafter, a method for producing the glass roll 1, which is an example of a glass article, will be described. In the producing method, the glass ribbon 2 is formed using the overflow down-draw method as a main process for producing the glass roll 1.

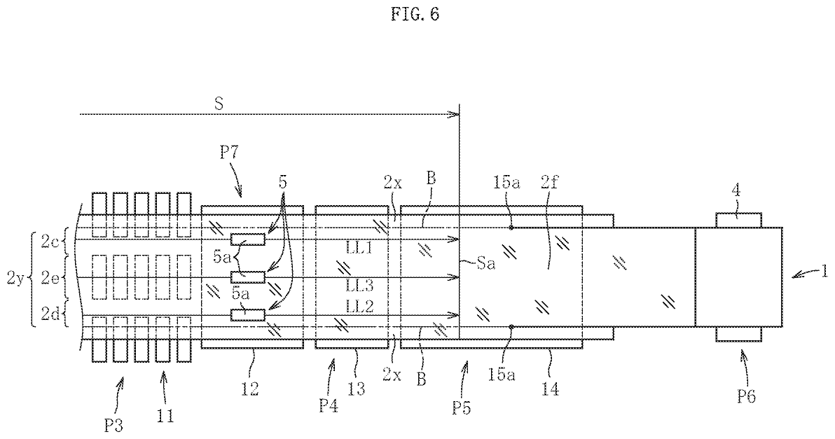

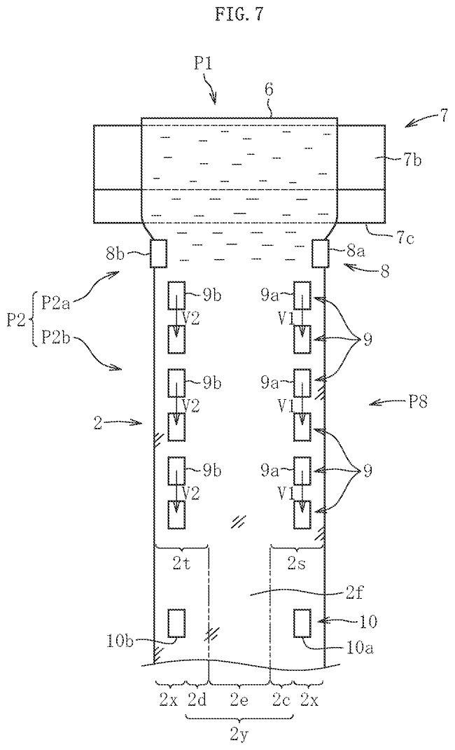

As illustrated in FIGS. 5 to 7, the producing method includes a forming step P1 of forming the glass ribbon 2 from molten glass 6, a transport step P2 (a vertical transport step) of transporting, along a transport path, the glass ribbon 2 at a temperature within a temperature range of 300° C. or higher, a transport direction changing step P3 of changing the transport direction of the glass ribbon 2 from the vertical direction to the horizontal direction, by transporting the glass ribbon 2 along a curved transport track, a horizontal transport step P4 of transporting, in the horizontal direction, the glass ribbon 2 after being subjected to the changing of the transport direction, a separation step P5 of cutting off unnecessary parts 2x at both the end portions in the width direction of the glass ribbon 2 being transported in the horizontal direction, to separate the unnecessary portions 2x from a necessary portion 2y, and a winding step P6 of winding, at a downstream end of the transport path, the glass ribbon 2 not including the separated unnecessary portions 2x and including only the necessary portion 2y into a roll shape to form the glass roll 1.

A formation body 7 for the overflow down-draw method, which has a wedge-like cross-sectional shape, is used to perform the forming step P1.

The formation body 7 includes a groove 7a formed in the top portion of the formation body 7 into which the molten glass 6 flows, a pair of side surfaces 7b and 7b along which the molten glass 6 overflowing from the groove 7a to both sides of the formation body 7 flows downward, and a lower end portion 7c at which the molten glass 6 flowing downward along one of the pair of side surfaces 7b and 7b and the molten glass 6 flowing downward along the other of the pair of side surfaces 7b and 7b are fused and combined. Then, the glass ribbon 2 is continuously formed from both of the molten glasses 6 that are fused and combined at the lower end portion 7c of the formation body 7.

The transport step P2 includes a cooling step P2a of cooling a first end portion 2s and a second end portion 2t of the glass ribbon 2 while transporting the glass ribbon 2, and an annealing step P2b of annealing the glass ribbon 2 after being subjected to the cooling step P2a while transporting the glass ribbon 2. In the annealing step P2b, the value of log η, which is a common logarithm of the viscosity 11 of the glass ribbon 2, is 14.5 Poise (1.45 Pa·s) or less. Note that the “first end portion 2s” includes the unnecessary portion 2x to be separated later from the necessary portion 2y, and a first end portion 2c of the necessary portion 2y in the width direction. Similarly, the “second end portion 2t” includes the unnecessary portion 2x to be separated later from the necessary portion 2y, and a second end portion 2d of the necessary portion 2y in the width direction.

To perform the transport step P2, rollers disposed vertically in a plurality of stages are used. The rollers include cooling rollers 8, annealer rollers 9, and support rollers 10 in the order from the top stage. The rollers 8, 9, and 10 each include a pair of rollers configured to sandwich the glass ribbon 2 from both the front and back sides and disposed so as to correspond to the first end portion 2s of the glass ribbon 2 in the width direction, and a pair of rollers configured to sandwich the glass ribbon 2 from both the front and back sides and disposed so as to correspond to the second end portion 2t of the glass ribbon 2 in the width direction. In the following description, the rollers of the rollers 8, 9, and 10 disposed so as to correspond to the first end portion 2s are referred to as “first rollers 8a, 9a, and 10a”, and the rollers of the rollers 8, 9, and 10 disposed so as to correspond to the second end portion 2t are referred to as “second rollers 8b, 9b, and 10b”. Note that, although a single stage of the cooling rollers 8, six stages of the annealer rollers 9, and a single stage of the support rollers 10 are disposed in the present embodiment, the number of stages of the rollers 8, 9, and 10 may be increased or reduced as appropriate.

The cooling rollers 8 are rollers for performing the cooling step P2a and provided immediately below the formation body 7 and have a function of suppressing shrinkage in the width direction of the glass ribbon 2 because each of the cooling rollers 8 is in contact with and cools a corresponding one of the first end portion 2s and the second end portion 2t of the glass ribbon 2. The annealer rollers 9 have a function of guiding the glass ribbon 2 downward in an annealing furnace (not illustrated) for performing the annealing step P2b, and in the annealing furnace, the glass ribbon 2 is annealed to a temperature equal to or less than the strain point, for example. The support rollers 10 have a function of supporting the glass ribbon 2 in the course of cooling the glass ribbon 2 to approximately room temperature, in a cooling chamber (not illustrated) provided below the annealing furnace.

Here, the annealer rollers 9 are described in detail. As described above, six stages of the annealer rollers 9 are disposed in the vertical direction. The first roller 9a and the second roller 9b of each of the annealer rollers 9 pull the first end portion 2s and the second end portion 2t of the glass ribbon 2, respectively. Increase or decrease in the pulling forces (speeds) of the first roller 9a and the second roller 9b results in increase or decrease in elongation amounts of the first end portion 2s and the second end portion 2t of the glass ribbon 2 (elongation amount along the longitudinal direction of the glass ribbon 2) being transported in the annealing furnace.

In an example, the glass ribbon 2 is formed to have a thickness of 300 μm or less. Note that the glass ribbon 2 is preferably formed to have a thickness of 200 μm or less, more preferably 100 μm or less, and most preferably 50 μm or less. The unnecessary portions 2x of the glass ribbon 2 include thickened edge portions having a greater thickness than that of other portions. Although the glass ribbon 2 is formed by using the overflow down-draw method in the present embodiment, the glass ribbon 2 may be formed by using the slot down-draw method, the redraw method, or the like in a variation of the present embodiment.

To perform the transport direction changing step P3, the roller conveyor 11 including a plurality of rollers arranged along the curved transport activation is used. The roller conveyor 11 smoothly changes the transport direction of the glass ribbon 2 from the vertical direction to the horizontal direction.

Conveyors 12 to 14 are used to perform the horizontal transport step P4. The conveyors 12, 13, and 14 transport the glass ribbon 2 in the horizontal direction.

To perform the separation step P5, a laser cutter 15 configured to cut the glass ribbon 2 by using the laser cleaving method is used. The laser cutter 15 emits laser beams 15a along boundary lines B between the necessary portion 2y and both the unnecessary portions 2x and 2x of the glass ribbon 2 such that both the unnecessary portions 2x and 2x are separated from the necessary portion 2y. Note that both the separated unnecessary portions 2x and 2x are caused to drop downward from the conveyor 14 and are discarded.

The winding core 4 and a sheet roll 16 formed by winding the band-like protective sheet 3 are used to perform the winding step P6. The glass ribbon 2, which includes only the necessary portion 2y and has reached the winding core 4 as a result of the transport, is wound around the winding core 4 in a state of being layered with the band-like protective sheet 3 supplied from the sheet roll 16.

In the producing method, the measurement step P7 and the adjustment step P8 are performed in addition to the steps P1 to P6 described above. Note that the steps P7 and P8 are not always performed. The steps P7 and P8 are performed intermittently at predetermined time intervals, or are performed after replacement of manufacturing equipment (e.g., replacement of the annealer rollers 9).

In the measurement step P7, along each of the first end portion 2c, the second end portion 2d, and the central portion 2e (in this case, the center position in the width direction) of the necessary portion 2y, a length from a leading portion Sa to a trailing portion Sb of a measurement target section S, which is a section along a longitudinal direction of the glass ribbon 2, is measured to obtain a first measured length LL1 to a third measured length LL3. As a manner of the measurement step P7, the first or second manner of measuring the first length L1 to the third length L3 described above can be employed, for example. In the present embodiment, the first manner described above is employed.

Here, the length of the measurement target section S (length along the longitudinal direction of the glass ribbon 2) can be any length, but the length of the measurement target section S is preferably 20 m or greater to accurately grasp the balance of the elongation amount between both the end portions 2s and 2t of the glass ribbon 2. Note that a “length of a measurement side target section S” used herein is a length along the center position in the width direction of the glass ribbon 2 (the necessary portion 2y). Thus, in the present embodiment, the third measured length LL3 is the length of the measurement target section S.

In a plurality of stages included in the six stages of the annealer rollers 9, a speed difference is provided between the first roller 9a and the second roller 9b (hereinafter, each of the plurality of stages may be referred to as “a stage provided with a speed difference”). In the adjustment step P8, to provide a speed difference between the first roller 9a and the second roller 9b, the magnitude of the speed difference (e.g., the difference in circumferential speed) is adjusted on the basis of the dimension difference between the first measured length LL1 and the second measured length LL2. This adjustment is performed to change relative balance between the pulling forces by both the rollers 9a and 9b to equalize elongation amounts of the first end portion 2s and the second end portion 2t of the glass ribbon 2. Note that both the rollers 9a and 9b are coupled to a different drive source (e.g., a motor), and a speed V1 of the first roller 9a and a speed V2 of the second roller 9b can be changed independently. Here, in the plurality of stages of the annealer rollers 9, the manner of providing the speed difference between the plurality of stages may be the same or different.

Hereinafter, the adjustment step P8 will be described in detail. Here, a case where the first measured length LL1 is longer than the second measured length LL2 in the result of the measurement step P7 is described as an example. Note that, the particular one of the first measured length LL1 and the second measured length LL2 is not always longer than the other one, and thus there may be a case where the other one is the longer. For example, such interchange of the longer length may occur when the annealer roller 9 is replaced.

In the present embodiment, the length of the measurement target section S is 100 m (i.e., the third measured length LL3 is 100 m), and in a case where the dimension difference between the first measured length LL1 and the second measured length LL2 is greater than 37 mm, which is set as a threshold value, the adjustment step P8 is performed. Note that the threshold value may be set to any value, for example, depending on the quality required for the glass ribbon 2 or a breakage situation of the glass ribbon 2.

One of the first end portion 2s and the second end portion 2t of the glass ribbon 2 having a relatively longer measured length based on the result of the measurement step P7 is defined as a long end portion, and the other of the first end portion 2s and the second end portion 2t of the glass ribbon 2 having a relatively shorter measured length is defined as a short end portion. In the present embodiment, the first end portion 2s is the long end portion, and the second end portion 2t is the short end portion. In other words, at the time before performing the adjustment step P8, the glass ribbon 2 is in a state where the elongation amount of the first end portion 2s is greater than the elongation amount of the second end portion 2t.

In the adjustment step P8, of the first roller 9a and the second roller 9b in the stage provided with a speed difference, the speed V1 of the first roller 9a, which is a roller on the side corresponding to the long end portion (the first end portion 2s), is reduced. On the other hand, the speed V2 of the second roller 9b, which is a roller on the side corresponding to the short end portion (the second end portion 2t), is increased. As a result, the elongation amount of the first end portion 2s is reduced and the elongation amount of the second end portion 2t is increased. In this way, the elongation amounts of both the end portions 2s and 2t are equalized. Note that in the present embodiment, the speed V1 of the first roller 9a and the speed V2 of the second roller 9b are the same at the time before performing the adjustment step P8, and thus the speed difference between both the rollers 9a and 9b is zero. On the other hand, in the cooling rollers 8, the support rollers 10, and the roller conveyor 11, there is no speed difference between both rollers corresponding to the first end portion 2s and the second end portion 2t, respectively, and the rollers rotate at the same speed, before and after the adjustment step P8.

In a variation of the present embodiment, to equalize the elongation amounts of both the end portions 2s and 2t, the speed V1 of the first roller 9a in the stage provided with a speed difference may be maintained at the speed before the adjustment step P8 and the speed V2 of the second roller 9b may be increased. Furthermore, in another variation, the speed V2 of the second roller 9b may be maintained at the speed before the adjustment step P8, and the speed V1 of the first roller 9a may be reduced. Note that in the present embodiment and the variations of the present embodiment, the relatively faster of the speed V1 and the speed V2 is preferably 100.1% or less of the relatively slower of the speed V1 and the speed V2.

Additionally, in a variation of the present embodiment, a speed difference between the first roller 9a and the second roller 9b may be provided in one or more (e.g., only one stage) of the plurality of stages of the annealer rollers 9 described above. Furthermore, the first roller and the second roller provided with a speed difference may be used in the transport step P2 (the vertical transport step). Thus, in the cooling roller 8 in addition to the annealer roller 9 (i.e., in the cooling step P2a in addition to the annealing step P2b), or in the cooling roller 8 instead of the annealer roller 9 (i.e., in the cooling step P2a instead of the annealing step P2b), the speed difference may be provided between the first roller 8a and the second roller 8b. In these cases, from the perspective of enhancing equalization between the elongation amounts of both the end portions 2s and 2t, the cooling rollers 8 are preferably disposed vertically in at least two stages and a speed difference is provided in the second and following stages, not in the first stage. Additionally, in any of the above-described cases, from the perspective of enhancing equalization between the elongation amounts of both the end portions 2s and 2t, two or more stages of the first rollers and the second rollers provided with a speed difference are preferably disposed, and three or more stages of the first rollers and the second rollers are more preferably disposed. Furthermore, in any of the above-described cases, a speed difference may be provided between the first roller 10a and the second roller 10b of the support rollers 10 disposed in the cooling chamber, in addition to the annealer rollers 9 and the cooling rollers 8.

In another variation of the present embodiment, a speed difference between the first roller and the second roller may be provided in a manner in which the focus is on the temperature range or the viscosity range of the glass ribbon 2 in the transport step P2. For example, when the focus is on the temperature range, the speed difference between the first roller and the second roller may be provided in a stage that is one of the stages of the rollers 8, 9, and 10 disposed in the vertical direction, and that is in contact with a region of the glass ribbon 2 at a temperature within a temperature range of 300° C. or higher during the transport step P2. From the perspective of efficiently equalizing the elongation amounts of both the end portions 2s and 2t, the temperature range is preferably 450° C. or higher, and more preferably 600° C. or higher. On the other hand, the upper limit of the temperature range is not particularly limited as long as the glass ribbon 2 can be formed, but a speed difference is preferably provided in the second and following stages, not in the first stage, as described above.

When the focus is on the viscosity range, the speed difference between the first roller and the second roller may be provided in a stage that is one of the stages of the rollers 8, 9, and 10 disposed in the vertical direction, and that is in contact with a region of the glass ribbon 2 having the value of log η being in the viscosity range of 28.1 Poise or less, Here, η is the viscosity of the glass ribbon 2 and log 11 is a common logarithm of η. From the perspective of efficiently equalizing the elongation amounts of both the end portions 2s and 2t, the viscosity range is preferably 22.0 Poise or less, and more preferably 17.0 Poise or less. On the other hand, the upper limit of the viscosity range is not particularly limited as long as the glass ribbon 2 can be formed, but a speed difference is preferably provided in the second and following stages, not in the first stage, as described above.

After performing the adjustment step P8, the measurement step P7 is performed again for a new measurement target section S that is different from the above-described measurement target section S. Note that the “new measurement target section S” is a section along the longitudinal direction of the glass ribbon 2 formed after performing the adjustment step P8.

If the result of the measurement step P7 performed again indicates that the dimension difference between the first measured length LL1 and the second measured length LL2 is 37 mm or less, it is considered that the elongation amounts of the first end portion 2s and the second end portion 2t of the glass ribbon 2 are equalized. In this case, the speed V1 of the first roller 9a and the speed V2 of the second roller 9b in the stage provided with a speed difference are maintained at the speeds after the adjustment step P8. Furthermore, the necessary portion 2y in the glass ribbon 2 formed under the condition after the adjustment step P8 is wound around the winding core 4.

On the other hand, if the result of the measurement step P7 performed again indicates that the dimension difference between the first measured length LL1 and the second measured length LL2 is still greater than 37 mm, the measurement step P7 and the adjustment step P8 are alternately executed until the dimension difference between the first measured length LL1 and the second measured length LL2 becomes 37 mm or less. In this case, the measurement target section S is changed to a new section each time the measurement step P7 is performed.

Note that, in the measurement step P7 performed one or more times, the surface 2f of a section of the necessary portion 2y selected as the measurement target section S may be contaminated due to the contact with the roller 5a provided in the roller encoder 5. Thus, the contaminated section may be separated from the section to be wound in the necessary portion 2y (the section to be actually wound around the winding core 4) and discarded. Furthermore, a section of the necessary portions 2y that has been formed before the dimension difference between the first measured length LL1 and the second measured length LL2 becomes 37 mm or less may also be separated from the section to be wound in the necessary portion 2y and discarded as a defective product.

According to the above-described method for producing a glass article, the glass ribbon 2 having the first end portion 2c and the second end portion 2d, the elongation amounts of which is equalized (the glass ribbon 2 including the necessary portion 2y only) can be wound around the winding core 4. Thus, it is possible to obtain the glass roll 1 with no defects due to the dimension difference between the first end portion 2c and the second end portion 2d, such as wrinkles formed on one side in the width direction or twisting.

Although the embodiment described above is an embodiment for producing the glass roll 1 as a glass article, no such limitation is intended. For example, an embodiment for producing, as a glass article, a glass plate cut from the glass ribbon 2 may be possible. In the embodiment, the glass ribbon 2 after being subjected to the transport step P2 is cut along the width direction, while being continuously transported in the vertical direction, and the measurement step P7 and the adjustment step P8 may be performed on the glass ribbon 2 before being cut. The thickness of the glass plate is, for example, from 200 μm to 2000 μm.

Although the measurement step P7 and the adjustment step P8 are provided in the embodiment described above, no such limitation is intended. For example, the measurement step P7 and the adjustment step P8 may be omitted, and on the basis of past operation results or the like, the first roller 9a and the second roller 9b provided with a speed difference are disposed, and the speed difference are set for the first roller 9a and the second roller 9b.

### Examples

To verify the effects of the present invention, the glass roll 1 was produced in a similar manner to the above-described embodiment. When producing the glass roll 1, the glass ribbon 2 was formed, and in the adjustment step, a speed difference between the first roller 9a and the second roller 9b was provided in one or more of six stages of the annealer rollers 9. Whether twisting occurred in the glass ribbon 2 was checked. The conditions of Examples 1 to 3 and Comparative Example were as described below in Table 1. Here, description of each item in Table 1 is given.

“Number of stages of annealer rollers” refers to the number of the stages of annealer rollers 9 disposed in the vertical direction, which are provided with a speed difference between the first roller 9a and the second roller 9b.

“Speed ratio” refers to a percentage of the speed of the relatively faster of the first roller 9a and the second roller 9b of the annealer roller 9 provided with a speed difference, with respect to the speed of the relatively slower.

“Glass viscosity” refers to a value of log η, where η is the viscosity of the glass ribbon 2 in a region where the annealer rollers 9 provided with the speed difference are disposed and log η is a common logarithm of η.

“Dimension difference between edges” refers to a dimension difference between the first measured length LL1 and the second measured length LL2 per 100 m length of the third measured length LL3, when the first measured length LL1 to the third measured length LL3 are measured in the measurement step P7.

TABLE 1

| | Compar- | | | |
|---|---|---|---|---|
| | ative | Example | Example | Example |
| | Example | 1 | 2 | 3 |
| Number of stages of | 0 | 1 | 2 | 3 |
| annealer rollers | | | | |
| Speed ratio [%] | — | 100.1 | 100.05 | 100.03 |
| Glass viscosity [poise] | — | 11.0 | 11.0 to | 10.6 to |
| | | | 11.6 | 11.6 |
| Dimension difference | 40 to | 11 to | 10 to | 4 to |
| between edges (in | 80 | 34 | 26 | 12 |
| terms of mm/100 m) | | | | |
| Occurrence of twisting | Poor | Marginal | Good | Good |

As a result of the verification, twisting was always observed in the glass ribbon 2 of Comparative Example, and thus Comparative Example was graded as “poor”. In Example 1, occurrence of twisting was suppressed within an acceptable range, and thus Example 1 was graded as “marginal”. In Examples 2 and 3, occurrence of twisting was not observed at all, and thus Examples 2 and 3 were graded as “good”. It is believed that these results were obtained because, in Examples 1 to 3, providing a speed difference between the first roller 9a and the second roller 9b equalized the elongation amounts of the first end portion 2s and the second end portion 2t in the glass ribbon 2.

### REFERENCE SIGNS LIST

1 Glass roll
2 Glass ribbon
2s First end portion
2t Second end portion
2g Edge on one side
2h Edge on one side
6 Molten glass
8a First roller
8b Second roller
9a First roller
9b Second roller
10a First roller
10b Second roller
L1 First length
L2 Second length
L3 Third length
LL1 First measured length
LL2 Second measured length
P1 Production step
P2 Forming step
P2a Cooling step
P2b Annealing step
P3 Transport direction changing step
P4 Horizontal transport step
P6 Winding step
P7 Measurement step
P8 Adjustment step
PS1 First position
PS2 Second position
PS3 Center position in the width direction
S Measurement target section
Sa Leading portion
Sb Trailing portion
V1 Speed of first roller
V2 Speed of second roller

1. A method for producing a glass article, the method comprising:
a forming step of forming a glass ribbon from a molten glass; and
a transport step of transporting the glass ribbon along a transport path, wherein
in the transport step, a first roller and a second roller are disposed for the glass ribbon at a temperature within a temperature range of 300° C. or higher and configured to transport the glass ribbon while in contact with a first end portion and a second end portion of the glass ribbon in a width direction, respectively, and a speed difference is provided between the first roller and the second roller.

2. The method for producing a glass article according to claim 1, further comprising:
a measurement step of measuring, along each of the first end portion and the second end portion of the glass ribbon, a length from a leading portion to a trailing portion of a measurement target section to obtain a first measured length and a second measured length, the measurement target section being a section along a longitudinal direction of the glass ribbon; and
an adjustment step of adjusting the speed difference between the first roller and the second roller, based on a dimension difference between the first measured length and the second measured length.

3. The method for producing a glass article according to claim 2,
wherein, in a case where one of the first end portion and the second end portion of the glass ribbon having a relatively longer measured length based on the result of the measurement step is defined as a long end portion, and the other of the first end portion and the second end portion of the glass ribbon having a relatively shorter measured length is defined as a short end portion,
in the adjustment step, the speed of one of the first roller and the second roller corresponding to the long end portion is reduced, and the speed of the other of the first roller and the second roller corresponding to the short end portion is increased.

4. The method for producing a glass article according to claim 1, wherein
the transport step includes a cooling step of cooling the first end portion and the second end portion of the glass ribbon, while transporting the glass ribbon, and an annealing step of annealing the glass ribbon after being subjected to the cooling step, while transporting the glass ribbon, and
the first roller and the second roller are used in at least one of the cooling step or the annealing step.

5. The method for producing a glass article according to claim 1, wherein the first roller and the second roller form a roller set, and a plurality of the roller sets are disposed along the transport path.

6. The method for producing a glass article according to claim 1, wherein a pair of rollers configured to sandwich the glass ribbon from both of front and back sides of the glass ribbon are used for the first roller and the second roller.

7. The method for producing a glass article according to claim 1, wherein the glass ribbon is formed by using a down-draw method.

8. The method for producing a glass article according to claim 1, further comprising a winding step of winding the glass ribbon into a roll shape at a downstream end of the transport path to form a glass roll.

9. A method for producing a glass article, the method comprising:
a forming step of forming a glass ribbon by using a down-draw method;
a vertical transport step of vertically transporting the glass ribbon;
a transport direction changing step of changing a transport direction of the glass ribbon from a vertical direction to a horizontal direction, by transporting, along a curved transport track, the glass ribbon after being subjected to the vertical transport step; and
a horizontal transport step of horizontally transporting the glass ribbon after being subjected to the changing of the transport direction, wherein
in the vertical transport step, a first roller and a second roller configured to transport the glass ribbon while in contact with a first end portion and a second end portion of the glass ribbon in a width direction, respectively, are disposed and a speed difference is provided between the first roller and the second roller.
